(19) United States
(12) Patent Application Publication
(10) Pub. No.: US 2007/0084411 A1
(43) Pub. Date: Apr. 19, 2007

(54) PET IMPACT PROTECTOR

(76) Inventor: Gary Ray Bennett, Alpharetta, GA (US)

Correspondence Address: GEORGE R. REARDON, 3356 STATION COURT, LAWRENCVILLE, GA, 30044, US

(21) Appl. No.: 11/550,257

(22) Filed: Oct. 17, 2006

Related U.S. Application Data
(60) Provisional application No. 60/727,337, filed on Oct. 17, 2005.

(51) Int. Cl. A01K 1/035

(52) U.S. Cl. 119/28.5

(57) ABSTRACT

A pet impact protector is disclosed. This device is directed to a cleanable, removable device for a vehicle car seat comprising a contiguous pliable material having a pet seating area and a pet capture area. This device is directed to the reduction of injury to a pet riding in a vehicle when a sudden stop or accident occurs.

This application claims priority to provisional application 60/727,337, dated Oct. 17,2005, which is incorporated herein in its entirety.

### FIELD OF THE INVENTION

The present invention relates to a pet vehicle accessory. Specifically, the present invention relates to a pet vehicle accessory that reduces the impact force to a pet riding in a vehicle when the vehicle stops suddenly or is involved in an accident.

### BACKGROUND OF THE INVENTION

It is becoming increasingly common for drivers of motor vehicles to carry a house pet or other animal in their vehicle. Safety concerns for these pets are important, as most pet owners can become very attached to a pet, which can be a loyal companion for many years, thus the life, health, and safety of the pet can be very important to its owner.

Various pet safety devices have been developed to protect a pet in an automobile from harm during normal driving conditions, harsh maneuvers, or during an accident, as well as to increase the comfort of a pet being transported in an automobile. While some safety seats and harnesses have been devised for pets, these devices generally do not achieve the equivalent degree of safety provided for human occupants of a vehicle. Also, not all drivers purchase harnesses for their pets, place the harness on the pet and secure those harnesses to the seat belt system of the vehicle.

The need for such pet safety devices does not exist when an automobile is operated without a pet on board. For maximizing the human passenger capacity of a vehicle, the owner of an automobile may, at times, wish to store a pet safety device while not in use. Therefore, it is desirable that a pet safety or restraining device be easy to store.

Heretofore, most automotive pet safety restraint devices have used harnesses and/or tethers to either connect the pet to a seatbelt or to some other part of the automobile. Other safety devices have used nets or the like to surround pets and confine them to a specific area. Still other pet safety devices use a specially designed car seat and tether the pet thereto.

Accordingly, a need arises for a device for pets which provides for a reduction of injury to a pet during sudden stops or an accident. Additional features of such a device should be ease of installation, ease of removal, ease of cleaning, and the like.

These and other problems exist. Previous attempts to solve these and other problems include the following.

U.S. Pat. No. 2,909,154, issued to L. E. Thomas on Oct. 20, 1959, discloses a tethering strap arrangement for animals riding in a vehicle.

U.S. Pat. No. 3,310,034, issued to H. S. Dishart on Mar. 21, 1967, discloses a safety harness and collar for pet riding in a vehicle.

U.S. Pat. No. D245,716, issued to Anthony J. Russo on Sep. 6, 1977 illustrates a car seat for a domestic animal.

U.S. Pat. No. 4,512,286, issued to Paul R. Rux on Apr. 23, 1985, discloses a pet container for an automobile having a hinged, multi-position front wall and a pet harness connected to the container by a leash.

U.S. Pat. No. 4,597,359, issued to Maurice D. Moorman. on Jul. 1, 1986, discloses a vehicle safety platform for a pet having horizontal mounting arms, a resilient base, a seat belt and a safety harness.

U.S. Pat. No. 4,896,630, issued to Therese G. Luce on Jan. 30, 1990, discloses an animal safety seat belt comprised of upper and lower restraints, front and rear straps, and a securement strap.

U.S. Pat. No. 4,907,541, issued to Paul L. Thompson on Mar. 13, 1990, discloses a pet restraint in a car having a harness with an adjustable flexible belly band, and a flexible chest band joined to the belly band.

U.S. Pat. No. 5,005,526, issued to Charles Parker on Apr. 9, 1991, discloses a collapsible vehicle safety apparatus for animals having a rigid base with a collapsible support frame and a pliable barrier cover attached to the base and held by restraining members.

U.S. Pat. No. 5,123,377, issued to Myrtis C. Edwards on Jun. 23, 1992, discloses a collapsible vehicle safety restraint and seat for pets that includes a padded seat pivotally extended from generally vertically disposed seat back which is removably affixed to an otherwise conventional vehicle.

U.S. Pat. No. 5,479,892, issued to Myrtis C. Edwards on Jan. 2, 1996, discloses a vehicle safety seat for pets having a pet seating portion removably disposed within base portion, with a vehicle safety seat secured to a vehicle passenger seat by securing the vehicle's seat belt portion through the vehicle seat belt passage of base portion.

U.S. Pat. No. 5,685,258, issued to Phillip Fricano on Nov. 11, 1997, discloses a car seat for animals especially dogs comprised of a horizontal seat with a backrest; seat has housing with recess for seat.

U.S. Pat. No. 5,794,571, issued to Carl L. Goldberg on Aug. 18, 1998 discloses a vehicular safety restraint for pets having two joined, closed loops with a breast strap set on the front loop and a tether on the rear loop which is passed through a connecting strap attached to the first loop.

U.S. Pat. No. 5,915,335, issued to Robert C. Holt, Jr. on Jun. 29, 1999, discloses a harness for a dog in an automobile.

U.S. Pat. No. 6,079,370, issued to Maad Al-Birmani and Yousef N. Al-Humidi on Jun. 27, 2000, discloses a car seat for transporting a pet having a net which is separable from and connectable to opposing sides of a back portion and has a predetermined length extending from the sides of the back portion.

U.S. Pat. No. 6,253,713, issued to Louis Albert, Giedeman, III, David James Hoffman, Irmina V. Reyes-Helfrich, Jeffery Kim and Gary Wight on Jul. 3, 2001, discloses a pet restraint system for motor vehicles.

U.S. Pat. No. 6,427,635, issued to Tammy Ballard on Aug. 6, 2002 discloses a vehicle safety restraint for canines comprised of an upper restraint, a lower restraint, a neck strap and a harness strap.

U.S. Pat. No. D461,966, issued to Houstene Reece on Aug. 27, 2002, illustrates an animal automobile seat.

U.S. Pat. No. 6,591,787, issued to James Gantz and Bette A. Gantz on Jul. 15, 2003 discloses a pet console seat for use in connection with automobiles comprised of a bar having a middle, and a seat frame having opposing ends with one end attached to the bar.

U.S. Pat. No. 6,637,377, issued to Mark Lobanoff and Ronald S. Gulette on Oct. 28, 2003, discloses an animal restraint system for a vehicle having a removable, spherically-shaped vest secured to the seat belt of the vehicle via a tether strap, with leg holes for the front legs of an animal.

U.S. Pat. No. 6,827,044, issued to Mark Lobanoff and Ronald S. Gulette on Dec. 7, 2004 discloses an animal restraint system for a vehicle having a top strap extending across the back of an animal wearing the vest from the first to second sides of a vest jacket when the jacket is on the animal to secure the vest to the animal.

While these patents and other previous methods have attempted to solve the above mentioned problems, none have addressed a device that protects a propelled pet against the impact caused by a sudden stop or accident.

Therefore, a need exists for an improved pet impact protector that incorporates solutions to these problems.

The foregoing patent and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

The general purpose of the present invention, which will be described subsequently in greater detail, is to provide a pet impact protector that provides a measure of protection against the pet hitting the dashboard of a vehicle during a sudden stop, is easily installed and removed from the car seat, and is washable.

In particular, embodiments of the present invention solve the above-mentioned problem of reducing the impact consequences to a pet due to sudden stops or accidents. Embodiments of the present invention cushion a pet that is propelled during a sudden stop or accident. Embodiments of the present invention are easily installed. Embodiments of the present invention are easily removed. Embodiments of the present invention are washable.

Embodiments of the present invention are comprised of a soft material that has cushioning properties, e.g. air inflation, foam. In one embodiment the pet impact protector device is made from a Polyurethane-Poly urea foam formulation having the properties of viscoelasticity, slow recovery, low density, flexible, integral skin/self skinning, optimum shock absorption and flexibility.

A variety of materials and shapes may be used in constructing the present invention, as long as the combination provides a soft impact area for a pet positioned properly in the event of a sudden stop or accident. The material may be single or double density and may be fade resistant. The construction of some embodiments of the present invention may utilize foam or foam-like materials.

The height of the present invention will be such that the driver will be able to see a passenger-side mirror. The top of the present invention may be of sufficient height to deter the pet from hitting the windshield.

In some embodiments of the present invention it may be operable and enabled for inflation. Embodiments of the present invention may be used in any of the seats of a vehicle other than the driver seat.

The pet impact protector reduces the G-force when a pet is hurtled toward the front of a vehicle due to a sudden stop or accident. Some embodiments of the present invention may have a handle for carrying. Some embodiments of the present invention may be weighted on the bottom to reduce movement during normal driving. Some embodiments of the present invention may have attachment areas for engaging the seat belts of vehicles.

In an exemplary embodiment the present invention has a seating area for a pet, a right side and a left side that are adjacent to the seating area and a front barrier facing the pet that provides cushioning for that part of the vehicle behind the front barrier, e.g. the dashboard, as the pet is propelled forward along with the pet impact protector device. In some embodiments the pet impact protector device may fold towards the pet in a manner similar to a baseball catcher's mitt.

In some embodiments the present invention may have one or more handles. In some embodiments of the present invention there may be means for releasable attachment to the vehicle seat belt assembly.

One advantage of the present invention is that it may decrease injury of a pet during an accident, or other sudden movement, of an automobile in which the pet is being transported.

Another advantage of the present invention is that it is easily installed on a car seat.

Another advantage of the present invention is that it is easily removed from a car seat.

Another advantage of the present invention is that it is easy to clean.

Another advantage of the present invention is that is can be made from inexpensive and easy to obtain materials.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The above summary of the present invention is not intended to describe each illustrated embodiment or every implementation of the present invention. The figures and detailed description that follow more particularly exemplify these embodiments.

### BRIEF DESCRIPTION OF THE SEVERAL VIEWS OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a front perspective view which illustrates a pet impact protector according to an embodiment of the present invention.

FIG. 2 is a top plan view which illustrates a pet impact protector according to the same embodiment of the present invention.

FIG. 3A is a left side plan view which illustrates a pet impact protector according to the same embodiment of the present invention.

FIG. 3B is a right side plan view which illustrates a pet impact protector according to the same embodiment of the present invention.

FIG. 4 is a bottom plan view which illustrates a pet impact protector according to the same embodiment of the present invention.

FIG. 5 is a rear plan view which illustrates a pet impact protector according to the same embodiment of the present invention.

FIG. 6 is a rear perspective view which illustrates a pet impact protector according to the same embodiment of the present invention.

FIG. 7 is a front plan view which illustrates a pet impact protector according to the same embodiment of the present invention.

FIG. 8 is a perspective view which illustrates a pet impact protector installed within a vehicle according to an embodiment of the present invention.

### DETAILED DESCRIPTION OF THE INVENTION

In the following description, numerous specific details are set forth in order to provide a thorough understanding of the present invention. It will be apparent, however, to one skilled in the art that these specific details need not be employed to practice the present invention. In other instances, well known materials or methods have not been described in detail in order to avoid unnecessarily obscuring the present invention.

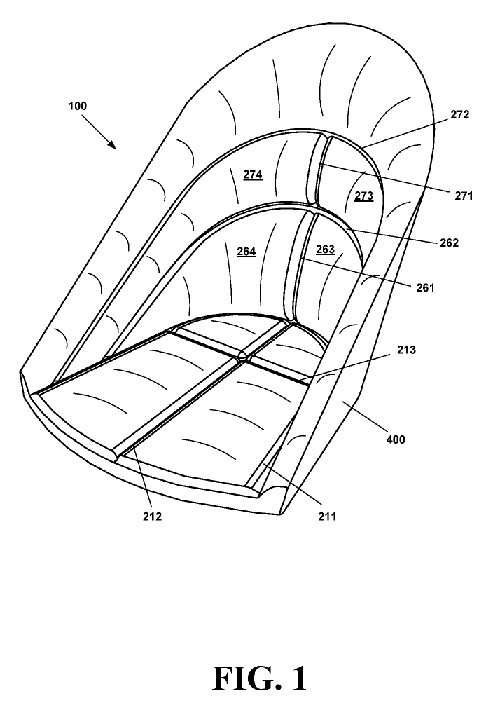

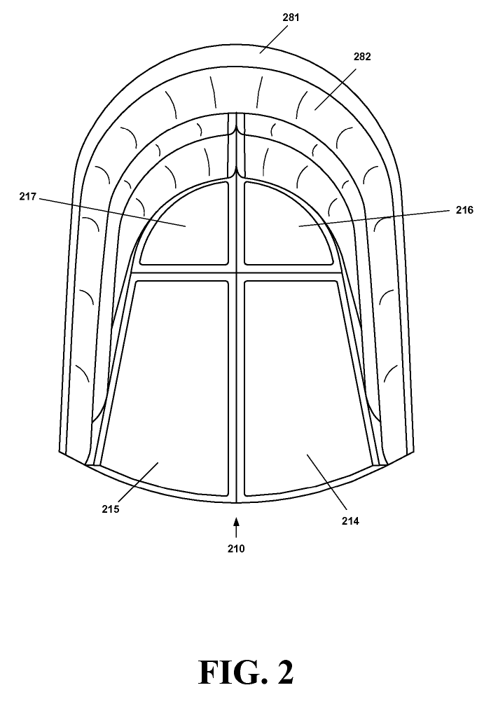

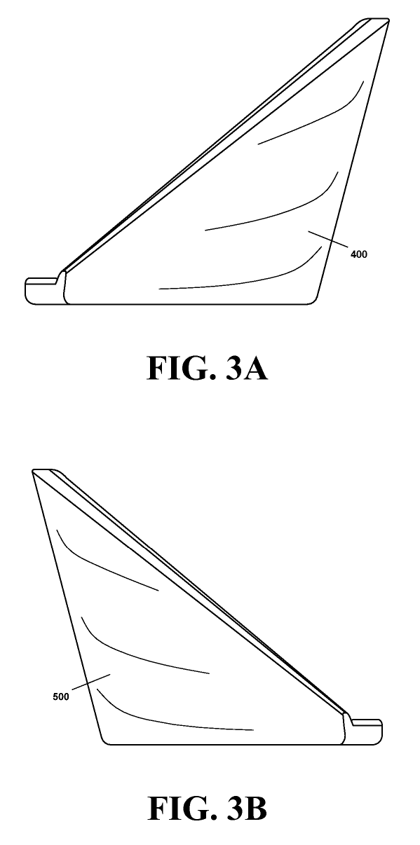

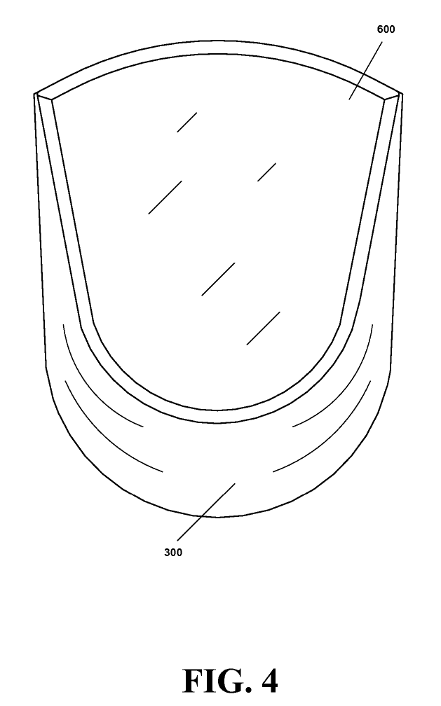

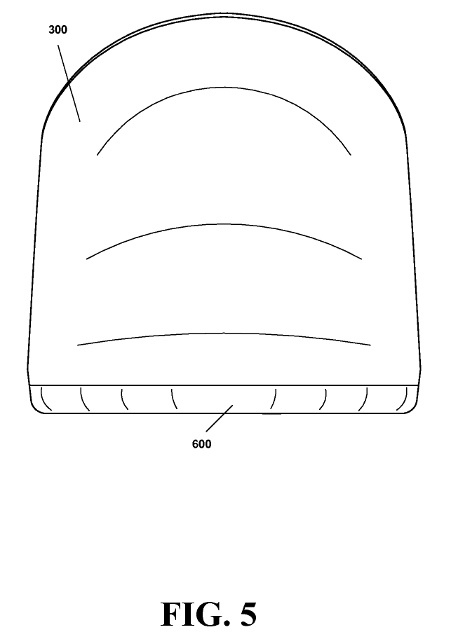

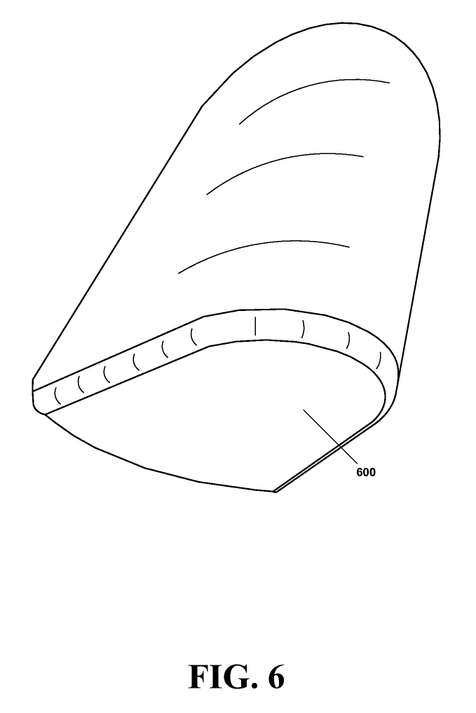

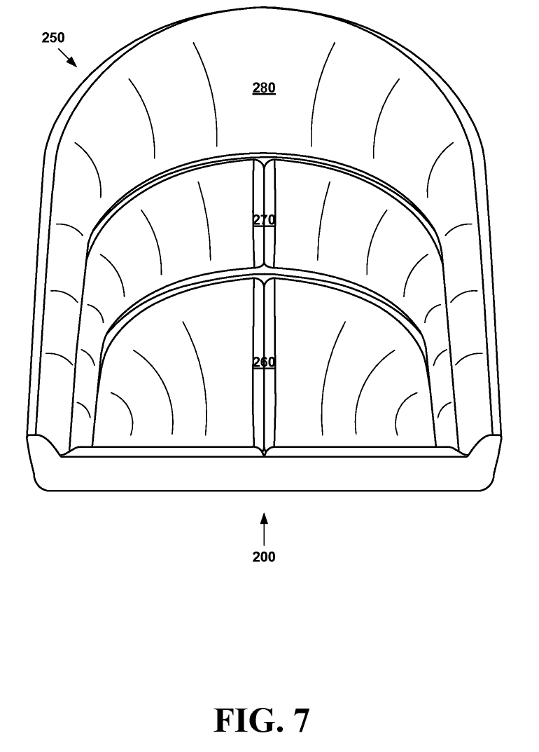

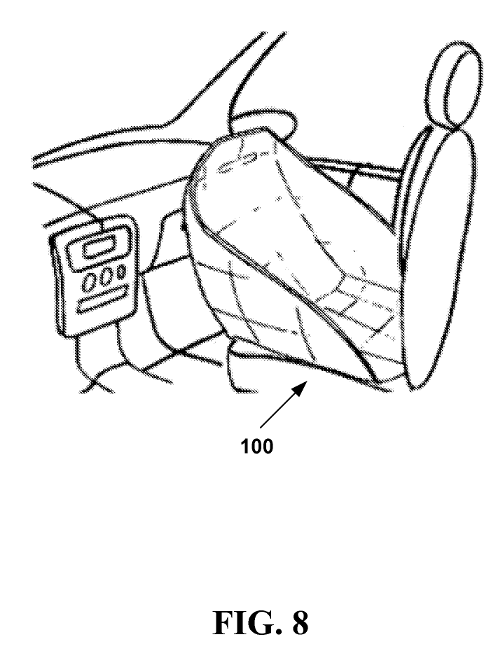

Referring now to FIG. 1 through FIG. 8, embodiments of the present invention are illustrated. An exemplary embodiment of a pet impact protector 100 is illustrated and is comprised of a front 200, a rear 300, a left side 400, a right side 500, and a bottom 600.

The front 200 is further comprised of a seating area 210 and a capture area 250. The capture area is angled away from the seating area at an oblique angle. The oblique angle may range from 1 degree to 45 degrees.

The seating area 210 is further comprised of a perimeter channel 211, a first dividing channel 212, and a second dividing channel 213. The first dividing channel 212 and the second dividing channel 213 intersect at substantially a right angle and divide the seating area 210 into four quadrants substantially as illustrated. These quadrants are labeled left proximal seating area 214, right proximal seating area 215, left distal seating area 216, and right distal seating area 217.

The capture area 250 is comprised of a first capture element 260, a second capture element 270 and a third capture element 280. Depending on the size of a pet and force of impact, a pet may be propelled into one or more of these capture elements, e.g. a miniature pet experiencing a moderate impact may come into contact with only the first capture element.

The first capture element is further comprised of a third dividing channel 261, a fourth dividing channel 262. The third dividing channel 261 and the fourth dividing channel 262 intersect to form a left first capture segment 263 and a right first capture segment 264.

The second capture element is further comprised of a fifth dividing channel 271 and a sixth dividing channel 272. The fifth dividing channel 271 and the sixth dividing channel 272 intersect to form a left second capture segment 273 and a right second capture segment 274.

The third capture element 280 is further comprised of a top edge 281 and a third capture segment 282.

The pet impact protector is preferably formed as a single unit through injection molding, but may be formed through other methods.

In one embodiment the pet impact protector device is directed to a cleanable, removable pet impact protector for a vehicle car seat comprising a contiguous pliable material having a seating area, means for cushioning the impact of a pet, means for securing the pet impact protector to an interior of a vehicle, and means for inflating the pet impact protector.

From the foregoing, it will be appreciated that, although specific embodiments of the invention have been described herein for purposes of illustration, various modifications may be made without deviating from the spirit and scope of the invention. For example, many of the features and components described above in the context of a particular pet impact protector configuration can be incorporated into other configurations in accordance with other embodiments of the invention. Accordingly, the invention is not limited except by the appended claims.

What is claimed is:

1. A pet impact protector having a seating area joined to a capture area, wherein the seating area is further comprised of a perimeter channel, a first dividing channel, and a second dividing channel, wherein the first dividing channel and the second dividing channel intersect at substantially a right angle and divide the seating area into four quadrants, and the capture area is comprised of a first capture element formed below a second capture element and a third capture element formed above the second capture element.

2. The pet impact protector of claim 1, wherein the four quadrants consist of a left proximal seating area, a right proximal seating area, a left distal seating area, and right distal seating area.

3. The pet impact protector of claim 2, wherein the first capture element is further comprised of a third dividing channel and a fourth dividing channel, and the third dividing channel and the fourth dividing channel intersect to form a left first capture segment and a right first capture segment.

4. The pet impact protector of claim 3, wherein the second capture element is further comprised of a fifth dividing channel and a sixth dividing channel and the fifth dividing channel and the sixth dividing channel intersect to form a left second capture segment and a right second capture segment.

5. The pet impact protector of claim 4, wherein the third capture element is further comprised of a top edge formed above a third capture segment.

6. The pet impact protector of claim 5, further comprising means for carrying the pet impact protector.

7. The pet impact protector of claim 7, further comprising means for securing said pet impact protector to an interior of a vehicle.

8. The pet impact protector of claim 7, further comprising means for inflating said pet impact protector.

9. A cleanable, removable pet impact protector for a vehicle car seat made from a contiguous pliable material comprising:
means for seating a pet; and
means for cushioning the impact of a pet,
wherein the means for cushioning the impact of a pet is angled away from the means for seating a pet at an oblique angle.

10. The pet impact protector of claim 9, wherein the oblique angle is between 1°-45 °.

11. The pet impact protector of claim 10, further comprising means for removing the pet impact protector from an interior of a vehicle.

12. The pet impact protector of claim 11, further comprising means for securing the pet impact protector to the interior of a vehicle.

13. The pet impact protector of claim 12, further comprising means for inflating the pet impact protector.
